(19) United States
(12) Patent Application Publication
(10) Pub. No.: US 2006/0080261 A1
(43) Pub. Date: Apr. 13, 2006

(54) Method and system for controlled play of digital downloads

(76) Inventor: Dean Vegas Christal, Santa Barbara, CA (US)

Correspondence Address: BARBER LEGAL, P.O. BOX 16220, GOLDEN, CO, 80402-6004, US

(21) Appl. No.: 11/123,952

(22) Filed: May 5, 2005

Related U.S. Application Data
(63) Continuation-in-part of application No. 10/963,917, filed on Oct. 12, 2004.

(51) Int. Cl. G06Q 99/00

(52) U.S. Cl. 705/52

(57) ABSTRACT

A method and system for digital file promotion by placing output circumscribed player terminals at commercial establishments. The terminal may be able to download digital files but be disabled from output of the downloaded files, so that users must enjoy the file on the player provided to/by the establishment. The POS station of the commercial establishment sells an access code such as a bar code on the POS receipt which the user then scans to receive a digital file play of a file downloaded from the Internet or a local memory device, the digital files played may be MP3 files, ring tones, music/video/data/test/game files or programs accessible for play for a limited number of times, a limited period of time, or as a promotion of other products sold by the commercial establishment, or offered for sale independently, or the file itself may be promoted.

### CROSS-REFERENCE TO RELATED APPLICATIONS

This application claims the priority and benefit of U.S. application Ser. No. 10/963,917 filed Oct. 12, 2004 in the name of the same inventor, Dean V. Christal, and entitled DIGITAL FILE CONSUMER GOOD PROMOTION METHOD AND VENDING MACHINE DEVICE, the entire disclosure of which is incorporated herein by this reference thereto, and U.S. application Ser. No. 10/978,498 filed Nov. 1, 2004 also in the name of the same inventor, Dean V. Christal, and entitled METHOD AND SYSTEM FOR CONTROLLED PLAY OF DIGITAL DOWNLOADS.

### STATEMENT REGARDING FEDERALLY FUNDED RESEARCH

This invention was not made under contract with an agency of the US Government, nor by any agency of the US Government.

### FIELD OF THE INVENTION

This invention relates generally to distribution and promotion methods and devices and specifically to a system providing enhanced downloads of digital files including games, data, books, music and video.

### BACKGROUND OF THE INVENTION

It is now well known that audio, video and digital files may be downloaded from Internet based services to home computers and thereafter downloaded to small portable player devices. The presently most popular form of this is the MP3 player, however, video content and data content may be so downloaded as well.

Less well known is the race to develop a commercially successful vending machine allowing this process. However, work is on-going in this area and the following list of patents shows the great interest in this. Most such devices concentrate upon the fundamental transfer and pay relatively less attention to successful commercialization of the concept. In particular, as of the date of application there has not yet been a commercially successful effort to vend digital music or video, despite attempts dating back at least five years.

Most such devices suffer from a fundamental marketing defect. The value of the digital content distributed must be outweighed by the gain to the commercial establishment offering the download. This is because the digital file downloaded is quite likely to be illegally copied almost immediately, then made available on large electronic networks to others willing to copy it illegally. For example, if a pop song is offered for sale on an Internet service formatted as an audio file (MP3, AU, WAV, and numerous other formats) then the song is quite likely to be available illegally shortly thereafter. This problem is so serious that some industry observers suspect the actual recording industry will be destroyed by it, and musical acts will return to earning money only from performing.

As a result, it behooves the download industry to consider methods by which digital files may be enjoyed by consumers as part of commercial establishment sales or promotions, and yet control access or circumscribe downloading so that the consumer may not copy and distribute the digital file illegally.

Patentability searching in the field yields a number of references.

US Patent Publication No. 2004/0086120 published May 6, 2004 in the name of Akins, III et al, teaches a satellite TV system for downloads and management thereof, and therefore teaches away from any vending related system of downloads.

US Patent Publication No. 2003/0061301 published Mar. 27, 2003 in the name of Chethik et al teaches a stereo system for downloads and management thereof, and therefore has the same problem that it teaches away from any vending related system of downloads.

US Patent Publication No. 2002/0069127 published Jun. 6, 2002 in the name of Enari teaches a method of acquiring file identification codes in order to speed purchases. The device teaches that a telephone may be used to acquire the codes prior to purchase at a store, thus teaching away from any vending machine or product placement.

US Patent Publication No. 2002/0042777 published Apr. 11, 2002 in the name of Yoshida et al teaches a method of providing credit in a recording medium.

U.S. Pat. No. 6,799,084 published Sep. 28, 2004 in the name of Grobler teaches a device for providing a CD or other known media format with music downloads or the like, and thus teaches away from use of a vending device or actual data player. It is also silent regarding methods of product promotion.

U.S. Pat. No. 6,779,115 published Aug. 17, 2004 in the name of Naim teaches use of a smart card for identity and credit determination of the user.

U.S. Pat. No. 6,711,464 published Mar. 23, 2004 in the name of Yap et al teaches a CD vending system and thus teaches away from use of MP3 players or product promotion methods.

U.S. Pat. No. 6,594,548 published Jul. 15, 2002 in the name of Bagnordi teaches use of PDAs, ebooks and smart cards to receive non-audio-video format works. It does not teach any methods of business development.

U.S. Pat. No. 6,567,847 published May 20, 2003 in the name of Inoue teaches a network system for allowing users to lay open their own works for public perusal. It does not as such deal with product placement nor promotion otherwise.

U.S. Pat. No. 6,535,791 published Mar. 18, 2003 in the name of Wang teaches a vending method directed towards printed materials, and thus teaches away from transfer of data files to the player of a user.

U.S. Pat. No. 6,507,727 published Jan. 14, 2003 in the name of Henrick teaches a method of identifying or securing music heard on broadcast radio stations.

U.S. Pat. No. 6,330,490 published Dec. 11, 2001 in the name of Kim et al teaches vending of traditional magnetic or optical devices of traditional CD or audio tape type, and does not deal with promotion of products.

U.S. Pat. No. 5,781,889 published Jul. 14, 1998 in the name of Martin et al teaches a method of managing a network of “jukebox” style music players, and thus teaches away from commercial downloads. U.S. Pat. No. 5,768,142 published Jun. 16, 1998 in the name of Jacobs teaches towards “expert” or relational suggestion of choices of files to users based upon the users' past buying choices. It thus teaches away from product promotion driven by commercial considerations.

US Patent Publication No. 2004/0193610 published Sep. 30, 2004 to Alex et al teaches a networked entertainment consol at a commercial establishment seating area. The device does not teach downloads.

US Patent Publication No. 2004/0159699 published Aug. 19, 2004 to Nelson et al teaches a point of sale station (POS station) which may use the Internet. It does not deal with downloads at all.

US Patent Publication No. 2004/0002359 published Jan. 1, 2004 to Deas et al teaches an automobile borne device for use with an “information filling station”.

US Patent Publication No. 2003/0191698 published Oct. 9, 2003 to Brown et al teaches using small portable computing devices as POS stations and interfacing with inventory control and the like.

US Patent Publication No. 2003/0004889 published Jan. 2, 2003 to Fiala et al teaches a product having a PIN number which is not accessible prior to sale of the product. However, this deals with packaging rather than downloads or access codes printed by a POS station.

US Patent Publication No. 2002/0194078 published Dec. 19, 2002 to Villaret et al teaches connection of a portable appliance such as a PDA or Bluetooth device directly to a POS station. The security disadvantages of such a system are manifest.

On-line copyright piracy has also been a significant problem. It would be preferable to provide users, especially young users, with a convenient, appealing and legal forum for play of downloaded files including games, video files, audio files, text files and other types of digital files.

In the unrelated field of automated carwash services, it is known to print out a small receipt on which a customer may find an access code good for a carwash at the service station selling the service.

It would be preferable to provide a system by which retailers, restaurants, malls and commercial establishments in general may be used to provide selective access to digital files without providing actual download of the digital files.

It would further be preferable to provide a system allowing such downloads without impacting the operations of the clerical personnel of the commercial establishment.

### SUMMARY OF THE INVENTION

General Summary

The present invention teaches a method and system for digital file promotion by placing output circumscribed player terminals at commercial establishments which prepossess a high volume of customer traffic. For example, hamburger stands and other restaurants, coffee shops, clothing outlets, sporting goods outlets, malls, food courts, video parlors, movie theaters, book stores or any other type of commercial establishment may receive a output circumscribed player terminal. The terminal may be a terminal able to download digital files but restricted or otherwise disabled from output of the downloaded files, so that users must enjoy the file on the player provided to/by the establishment.

The point-of-sale (POS) station (cash register) of the commercial establishment sells an access code which the user then enters via scanning or manual or electronic entry to the output circumscribed player terminal in order to receive a digital file download. Thus, the customer makes a transaction with the sales clerk in a traditional manner, in embodiments identifying the digital product desired and in other products not doing so. The sale is completed by any normal commercial process at the POS station. The access code provided may be provided electronically, however, in the presently preferred embodiment, the access code is printed on a small piece of paper such as the sales receipt. The sale may include price terms (such as a free giveaway of the digital file product, rendering it a “no cost” sale), sale terms, discounts, tie-ins, and the like.

The access code may identify the digital file to play or download on the output restricted player, or the user may identify the file to download when the user reaches the output circumscribed player terminal. The user may identify the desired product using programable softbuttons present either on a video screen of the terminal or as reprogrammable hard buttons. The user may in embodiments have no choice of download, or source of the digital download, or may be offered a choice coming from a download library source within the terminal, or a remote library file source elsewhere, or may even have a choice of different sources.

The digital files downloaded may be MP3 files, ring tones, music files, video files, data files, test files, programs, game files and combinations thereof.

The invention includes an output device allowing the user to attach a player to accept the downloaded file. The player may be an MP3 player, a video player, a PDA, a game player, a small computer, a telephone, camera, other consumer electronic devices, similar devices and combinations thereof.

The file may be accessible for play for a limited number of times, for a limited period of time, or otherwise limited. The file play may be provided as a promotion of other products sold by the commercial establishment, or the file play may be offered for sale independently, or the file itself may be promoted by attachment to a commercially popular product, or combinations thereof.

Summary in Reference to claims

It is a first aspect, advantage, objective and embodiment of the present invention to provide a method of accessing digital files comprising the steps of:
a) providing to a commercial establishment having pre-existing customer traffic an access controlled and output circumscribed player terminal located at the commercial establishment;
b) distributing an access code at a point of sale station at the commercial establishment;
c) inputting the access code at the output circumscribed player terminal; and
d) accessing a digital file for play on the player terminal.

It is a second aspect, advantage, objective and embodiment of the present invention to provide a method wherein the digital file further comprises one member selected from the group consisting of: MP3 files, music files, video files, data files, book files, text files, game files and combinations thereof.

It is a third aspect, advantage, objective and embodiment of the present invention to provide a method further comprising the step of:
e) providing video advertising on the terminal when not in use.

It is another aspect, advantage, objective and embodiment of the present invention to provide a method wherein the access code further identifies the digital file to be downloaded.

It is another aspect, advantage, objective and embodiment of the present invention to provide a method wherein the terminal further comprises at least one softbutton identifying the source of the digital file to play, and further comprising the step of:
c1) selecting the digital file to play.

It is another aspect, advantage, objective and embodiment of the present invention to provide a method wherein the distribution of the access code further comprises a sale of the commercial establishment.

It is another aspect, advantage, objective and embodiment of the present invention to provide a method wherein the inputting the access code at the output circumscribed player terminal further comprises one member selected from the group consisting of: scanning in a machine code, reading an electronic code, punching in a code manually on a keypad, and combinations thereof.

It is another aspect, advantage, objective and embodiment of the present invention to provide a method wherein the step d) of accessing a digital file for play on the output circumscribed player terminal further comprises one member selected from the group consisting of: d1) downloading the digital file from a large electronic network to the output circumscribed player terminal, d2) retrieving the digital file from memory within the output circumscribed player terminal or combinations thereof.

It is another aspect, advantage, objective and embodiment of the present invention to provide a method further comprising:
e) limiting access to the digital file for play on the output circumscribed player terminal by means of one member selected from the group consisting of: limiting access based upon time, limiting access based upon date, limiting access to a number of plays of the digital file, limiting access to a period of time, limiting access based upon the code generated by the POS station, limiting access based upon the value of a purchase made at the POS station, limiting access based upon the identity of a purchase made at the POS station, and combinations thereof.

It is yet another aspect, advantage, objective and embodiment of the present invention to provide a digital file player system allowing a commercial establishment to promote digital file play, the player system comprising:
a) an output circumscribed player;
b) a code input device;
c) a download management module allowing download of at least one digital file to the output circumscribed player upon entry of a code at the code input device.

It is yet another aspect, advantage, objective and embodiment of the present invention to provide a digital file player system wherein the digital file further comprises one member selected from the group consisting of: MP3 files, music files, video files, data files, book files, text files, game files and combinations thereof.

It is yet another aspect, advantage, objective and embodiment of the present invention to provide a digital file player system further comprising:
d) a programmable softbutton allowing selection of at least one desired digital file to be played on the player.

It is yet another aspect, advantage, objective and embodiment of the present invention to provide a digital file player system further comprising:
e) a point-of-sale station having a module able to generate the access code.

It is yet another aspect, advantage, objective and embodiment of the present invention to provide a digital file player system further comprising:
f) an operative electronic connection to a large electronic network of the digital file.

It is yet another aspect, advantage, objective and embodiment of the present invention to provide a digital file player system further comprising:
g) an operative electronic connection to a terminal control unit having a module remotely altering the operation of the terminal.

It is yet another aspect, advantage, objective and embodiment of the present invention to provide a digital file player system, further comprising:
h) playing controls suitable for playing one member selected from the group consisting of: a digital file game, a digital music file, a digital video file, and combinations thereof.

It is yet another aspect, advantage, objective and embodiment of the present invention to provide a digital file player system wherein the access code further comprises one member selected from the group consisting of: a bar-code, another machine code, an electronic code, a number, and combinations thereof.

### BRIEF DESCRIPTION OF THE DRAWINGS

FIG. 1 is a front view of an output circumscribed player terminal according to the invention.

FIG. 2 is a schematic front view of a commercial establishment according to the invention.

FIG. 3 is a schematic view of a network according to one alternative embodiment of the invention.

FIG. 4 is a schematic view of a network according to a second alternative embodiment of the invention.

FIG. 5 is a flow chart of the method of the invention.

FIG. 6 is a front view of an output circumscribed terminal according to another alternative embodiment of the invention.

FIG. 7 is a front view of a POS station sales receipt with the access code generated by the POS station, in this embodiment a bar code.

### INDEX TO THE REFERENCE NUMERALS

Output circumscribed player terminal 102
Video screen 104
Download/management/local memory module 106
Game controls/keypad 108
Video softbutton 110
Hardware softbutton 112
Scanner 114
Commercial establishment 202
POS station 204
Wall 206
Output circumscribed player terminal (wall) 208
Limit access/output circumscribed player terminal (table mounted) 208′
Large electronic network/Internet 302
Local memory 303
Networked output circumscribed player terminal 304, 306
Operative electronic connection 308a, 308c
Networked digital file source 310
POS station 312
Operative electronic connection 314, 316
Commercial establishment 318
Player network download/management module 402
Networked output circumscribed player terminal 404, 406
Operative electronic connection 408a, 408c
POS station 412
Operative electronic connection 414, 416
Commercial establishment 418
Output circumscribed player terminal 602
Video screen 604
Body 606
Code Scanner 608
Video softbutton 610
Download management module 614
Player controls/softbuttons 620
Advertisement 658
POS receipt 750
Purchase/promotion 752
Access code/bar code 754
Provide commercial establishment 1000
Provide terminal 1002
Sell access code at POS 1004
Input access code at terminal 1006
Select file 1008
Limit file play 1010

### DETAILED DESCRIPTION

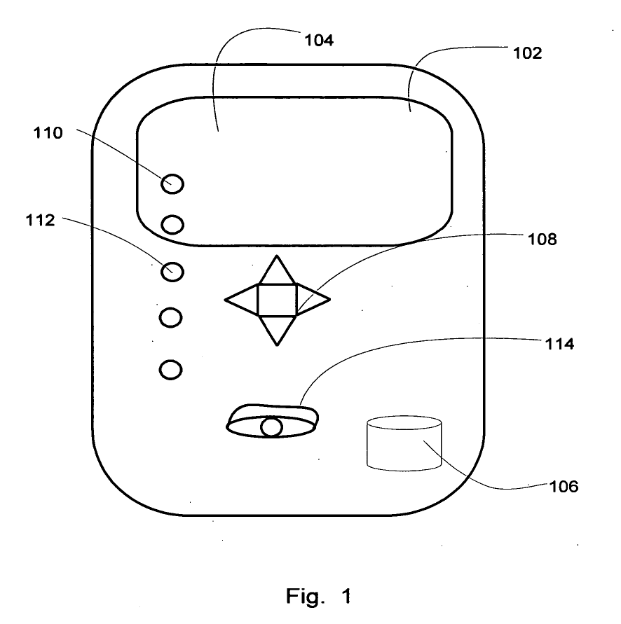

FIG. 1 is a front view of a output circumscribed player terminal according to the invention. This terminal may be independent of any network connection or may be networked in embodiments: the access controlled output restricted terminal may be a download terminal in that it receives downloads from large electronic networks, but it is different in the crucial addition that it may not normally allow a public download of digital files: instead, this form of terminal will itself allow play of the digital file to customers of a commercial establishment.

Output circumscribed/limited access player terminal 102 may be a small device large enough to allow easy human input but small enough to be easily mounted on a counter top or wall or other out of the way location. It may in embodiments be free standing. It may function as a video player, a game player, a music player, a text player or similar device able to play digital files.

Video screen 104 may be used to allow users to identify their choice of digital file or source of digital file. It may also be used for advertising purposes, particularly in embodiments in which the video screen is extremely large or covers one entire side of the machine. Video screen 104 may be touch sensitive, as noted two paragraphs below in reference to softbuttons. Video screen 104 may incorporate a speaker to allow audio output, this is useful for adding impact to advertising and is necessary for most video files and game files.

Download/management/local memory module device 106 may be a download/management module allowing download of files from large networks such as the Internet, may control operations of the terminal, specifically controllers for buttons and play controls, may have sub-modules able to receive the access code and verify that it is correct, modules to carry out secondary advertising functions of the terminal and other control tasks as needed. Download/management module 106 may further comprise a mass storage device for digital data which allows the terminal to maintain a digital file ready for download by users. In embodiments, download/memory module 106 may allow storage of more than one selection of digital file, and modules allowing user selection of the desired module, for example by means of video softbutton 110 and/or hardware softbutton 112.

Player controls/keypad 108 may advantageously be a very simplified keypad of low cost and small size, for example a standard 12 key pad having the numerals 0 through 9, an asterisk key and a pound sign key, or a rose of arrow buttons for game play, standard buttons for playing of linear access files (play, fast forward, rewind, skip, pause, etc). Smaller selections of keys allow a smaller overall terminal and reduce cost. As few as two keys may easily be used to provide control most file play, though more keys provide greater options and security. The keypad may also be used to input access codes manually in alternative embodiments.

Larger keypads, even keyboards having 100 or more keys, may advantageously be used in embodiments in which functions in addition to mere entry of the access code or play of a simple data file are contemplated. For example, the device may allow access and input, even text input, to a network based file system.

In one alternative embodiment, the keypad may be eliminated and the softbuttons may be used in place of that. For example, five softbuttons allow secure access codes, and being softbuttons, could be programmed to switch after code entry to have an entirely different function such as game play controls, audio play controls, video play controls and so on. A keypad or keyboard may thus be implemented on the touch sensitive screen embodiments, thus eliminating the need for any keypad whatsoever.

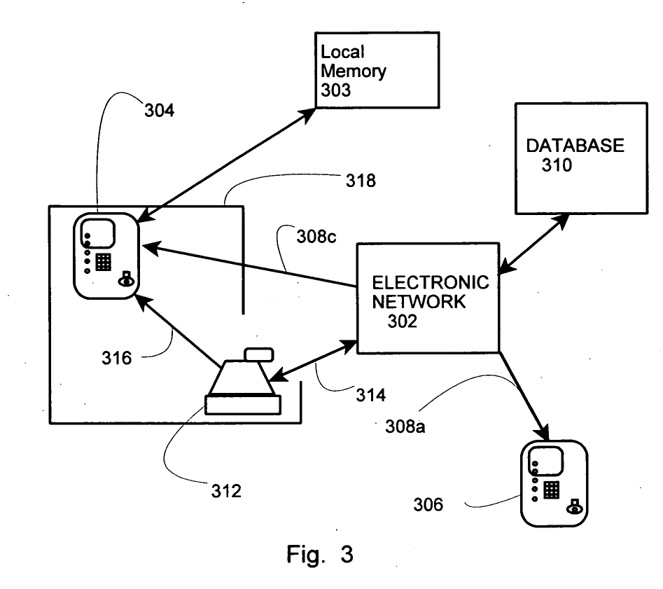

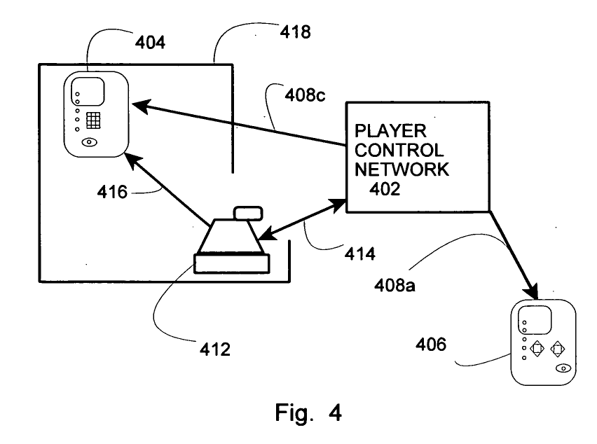

Softbuttons 110, 112 may be used to provide easier access to digital files to be played, downloaded from a network or accessed from local memory. For example, a video game (for which the commercial establishment having the terminal may also have exclusive rights of distribution) may be assigned a softbutton for a period of time so that the increased volume of users desiring that product may download it into the output circumscribed game players with relative ease. A popular music file in MP3 or another common format may be assigned a softbutton to provide easy access to that particular popular file. Entire libraries owned by companies which compile and maintain databases of digital files may be assigned to a button, or other commercial or data structures may be. The advantage of a softbutton in this area is that by definition, a softbutton is one that is easily reprogrammable rather than assigned a fixed value unlike the digits on the access code keypad. This allows swift reprogramming in response to changes in the commercial situation. Such reprogramming may occur on-site at each machine or in embodiments the machines may be reprogrammed remotely. Such remote reprogramming may occur (in the embodiments discussed in reference to FIGS. 3 and 4) via a download network unit, or at the POS, or via a network or dial-up connection unrelated to the download function of the terminal, such as a network dedicated to the reprogramming function only.

The device may use a standard scanner 114 to read access codes printed in machine readable format, which is the preferred embodiment and best mode now contemplated. There are numerous such formats, such as bar codes, machine readable numerals, and the pseudo-random patterns used in modern postage metering schemes. All such formats now known or later developed may be used to print and scan the access code. A bar code such as POS stations are already easily capable of producing is advantageous and is contemplated in the preferred embodiment. Such bar code readers (for example, supermarket Universal Product Code readers) are already common and inexpensive.

One purpose of the invention is to track royalty rights of performers, artists, programmers, writers and other intellectual property owners. Due to the increasing ease of theft of electronic files containing music, movies, games and the like, it has become almost impossible to prevent quick copying of most materials. In general, by use of the access code system, theft of songs, videos, movies, games, books and other digital files may be prevented. In addition, the system allows easy tracking (in the download management module or the network management unit of networked embodiments) of royalties owed and parties the royalties are owed to.

One very important security aspect of the invention is to avoid the necessity of allowing users to hook electronic appliances to the POS stations of commercial establishments, a security prospect, unappetizing to the typical retailer. Several new business structures for profiting from electronic files and their content may be enabled by means of the method and device of the present invention.

For example, a popular song could be made available only to customers of a given establishment. In order to hear the song, it would be necessary to access the players of the selected commercial establishment, which might make play available for a nominal or low fee. The same principle may be applied to game and video play. Thus numerous marketing stratagems are possible in the method of the invention. For example, a popular singer may have a new song to be promoted. A commercial establishment may use the royalty control capabilities of the invention to “lock up” rights, thus becoming the only purveyor of a potentially very popular song. In another embodiment, a highly touted game may be offered exclusively through the franchise or chain of the commercial establishment. Such rights may be exclusive, non-exclusive, time limited, may require payment of a single large fee for unlimited play rights, may require payment per play, and so on. In addition, such play may be then tied into the products of the commercial establishment. These techniques allow tie in to actual player sales, in which the user gets free plays or the goods of the commercial establishment on a discounted or free basis due to having used a player. It may also be advantageous to allow promotion of the products of the commercial establishment in parallel with promotion of a digital file. Co-branding or tie in possibilities may be made available to marketers, as well as the possibility of using a popular product to promote a digital file or using a popular digital file to promote a commercial establishment or product.

Security is maintained, however, by means of an output circumscribed player which may be able to download from electronic libraries on an electronic network but which has not output functionality.

The term “output circumscribed” as used herein may mean a player which deliberately has no output ports, or which has output ports not available to the public (for example physically locked within the body of the device), or which requires special coding or authorization in order to permit output, or combinations thereof.

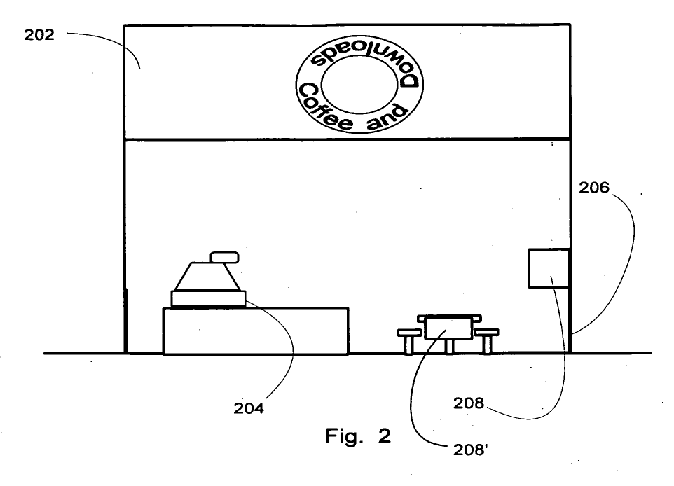

Thus, FIG. 2 is a schematic front view of a commercial establishment according to the invention. Commercial establishment 202 is depicted as a coffee shop or fast food restaurant, but it may be any type of commercial institution in which a high volume of customer traffic may be expected, such as hamburger stands and other restaurants, clothing outlets, sporting goods outlets, malls, food courts, video parlors, movie theaters, book stores or any other type of commercial establishment may receive a output circumscribed player terminal.

POS station 204, walls, tables, display areas, counter tops, pillars, furniture and so on are normal parts of such establishments. Wall 206 may have thereon output circumscribed player terminal 208 according to the present invention, but the other structure listed may of course receive the output circumscribed player terminal instead.

One presently preferred embodiment and best mode now contemplated for carrying out the invention teaches that the invention may be located in a table, for example, with the screen as part of the table surface. Table/table mounted player 208′ is an example of this. Such embodiments allow players to sit at the benches or chairs about the table while playing the file. This may make for a longer term play period due to greater comfort, may produce a more social play atmosphere, may conserve space in the commercial establishment (many of which greatly value productive/profitable floor space)

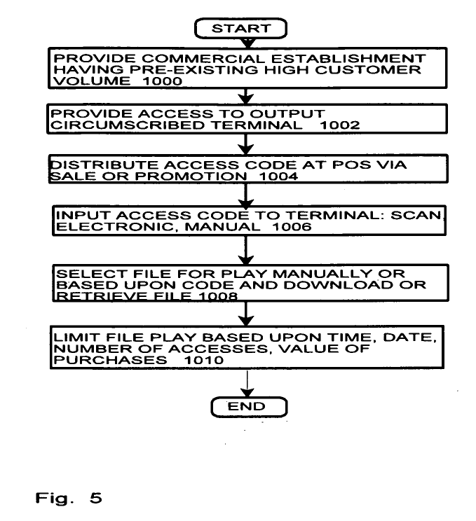

FIG. 5 is a flow chart of the method of the invention, as might be carried out at a commercial establishment. The first step is to provide a commercial institution having high customer traffic, this “provision” may be by creation of such an operation or merely by selection of a retail establishment, entering into an agreement with such an operation or so on, all of which and equivalents being subsumed within step 1000, “Provide commercial establishment”.

Provide access to output circumscribed and access controlled terminal 1002 may consist of placing the terminal on a public wall, built into a counter top or table (as shown in FIG. 2) or it may be otherwise be made publically accessible to the customers of the establishment.

Distribution of access code at POS 1004 teaches that the access code may be sold by the clerical staff of the establishment as part of another sale (“Buy a hamburger, get a download for 25 cents”), by itself (“Any download, just 49 cents!”), in quantity, as a free giveaway or other free inducement, and so on. In any case, the customer indicates that they wish to buy a download, and depending upon the embodiment of the invention, either identifies the desired content to the sales person or does not. The sales clerk rings up the sale in the usual manner, using the devices and subsystems of the POS station. In alternative embodiments, the POS station may then immediately transmit the “identity” of the access code to the output circumscribed player terminal. In other embodiments, the access codes may be provided to the POS station by the output circumscribed player terminal, or may be provided to both by a third unit. A number of access codes may be active in the output circumscribed player terminal, and the POS station may simply select from that list when providing on the customer. In one embodiment, a small machine “behind the counter” provides the access code (either numeric or bar code or electronic or otherwise) at the push of a button. The machine is controlled by the clerks at the POS station, who when selling a download or giving one away for free as part of a promotion, or whenever a download is authorized, simply use the small access code providing machine at/near the POS station to print out or electronically encode the access code.

It is also possible to electronically encode the access code. For example, the access code may be encoded into a small electronic memory device such as an “electronic key” (magnetic card, memory stick, etc) or may be electronically associated with a credit card of the customer, who then swipes the credit card at the reader of the player not for payment but for identification.

The access code may be printed out on the customer's receipt, or it may be printed out by the POS station on another slip of paper. Advantageously, the access code may be a barcode such as is already commonly used to identify cards and merchandise to scanners. It may also be placed into an electronic device by the POS station, though this embodiment may be complex and less secure.

Input access code at terminal 1006 is the step of the user scanning, inserting or punching the access code into the keypad and being informed that it has been accepted by the terminal and that they may begin a download.

In embodiments, the access code input may be time limited. In one embodiment, this time limit may allow the code to be used until a certain time has passed, thus requiring users to make use of the download within a period of time. However, in another embodiment, the access code may be used after a certain time has passed, thus requiring the user to come back to the commercial establishment on a later date. In addition, both techniques may be used for the same access code. In addition, the limitation may be the limiting of access to a certain number of plays of the digital file, limiting access based upon the code generated by the POS station, limiting access based upon the value of a purchase made at the POS station, limiting access based upon the identity of a purchase made at the POS station, and additional combinations thereof or combinations with other types of limits, such as limits based upon time of day, day of the week, or store hours or the like.

In steps, the method may comprise:
a) providing to a commercial establishment having pre-existing customer traffic an access controlled and output circumscribed player terminal located at the commercial establishment;
b) distributing an access code at a point of sale station at the commercial establishment;
   b1) distributing the access code as part of a sale or promotion of products of the commercial establishment;
c) inputting the access code at the output circumscribed player terminal;
   c0) inputting the access code by means of optical scanning, electronic device, manual entry, or combinations thereof;
   c1) selecting the digital file to play;
   c2) wherein the access code further identifies the digital file to be downloaded;
d) accessing a digital file for play on the player terminal
   d1) downloading the digital file from a large electronic network to the output circumscribed player terminal;
   d2) retrieving the digital file from memory within the output circumscribed player terminal or combinations thereof;
   e) limiting access to play of the digital file based upon time, date, number of plays of the file, code generated by the POS station, purchase made at the POS station, commercial establishment hours of operation, completion of a consumer survey, answers on a consumer survey or combinations thereof;
f) providing video advertising on the terminal when not in use. Download digital file 1008 may include a number of other steps, such as selection of the digital file, selection of the source of the digital file, viewing advertisements, answering brief marketing surveys and the like. The customer will also establish an operative connection between their player device and the output device. This may be an electronic connection, a wireless connection and so on. The download management module 114 will handle the “electronic housekeeping” aspects of the download, in a manner known to those skilled in the art.

The method and device of the invention may be used to gather information from the consumer as well. Obtaining consumers' information has an enormous value to retailers, marketers, distributors, investors, artists, studios and the commercial establishment itself. Information specifically relating to the data file downloaded or information specifically relating to the consumer goods of the establishment or specifically relating to the consumer all have value. Such information may be obtained by means of a consumer survey, may be associated with a specific consumer identity, and may involve offering to such consumer a secondary commercial reward

Thus, the machine may be used to gather information from the consumer. In an embodiment in which the offer of a digital download is associated with the offer of a product such as a particular type of coffee or hamburger, the gathering of such information may in fact be automatic: the provision of an access code by the commercial establishment automatically provides tracking of the fact that consumers ordering the file were the same consumers ordering a particular consumer good.

The information may also be gathered by surveying the customer with the customer's knowledge and consent, for example, by asking the consumer to answer questions. An additional or secondary commercial reward may be offered to assist with this gathering, i.e. a coupon good for either additional file downloads or for a consumer good of the establishment. This is referred to as a secondary commercial reward because the primary commercial reward to the consumer is the co-marketed products of download file and consumer good. The secondary commercial reward may of course be an actual download or consumer good, and may be omitted in systems in which provision of such information is necessary to obtain the digital download file at all.

Such information may be associated with a specific consumer identification such as name, customer number or the like. Such association greatly increases the value of the information by allowing marketers to niche market to smaller sections of the population more appropriate to a given product or promotion.

Information gathered may be of any type. Obviously, it may concern the consumer themself: name, age, gender, income, spending habits, employment, personal taste in music, preferences in electronic goods or other consumer goods, knowledge of products and services, etc. However, the information gathered may also concern digital files: identity of the desired file and of other desired files, favorite sources of digital files (musical groups, musicians, recording studios, on-line services, etc). It may also advantageously concern the preferences of the consumer in regard to the goods/services of the commercial establishment. Thus a restaurant might query consumers regarding their appreciation of various items of food or drink, their taste in restaurants, reasons for making a purchase and so on. This last type of information may make the invention highly valuable to commercial establishments.

Access to the file at the player may be limited based upon the user's willingness to complete a consumer survey, or even based upon the actual answers provided in the consumer survey, provided that the second option is implemented in a morally non-discriminatory manner.

FIG. 3 is a schematic view of a network according to one alternative embodiment of the invention. Large electronic network 302 may be the Internet, or it may be a vending network management module or network. “Networked” output circumscribed player terminals 304, 306 have operative electronic connections 308a, 308c thereto. Digital file source 310 is illustrated to show that it may be external to both the Internet/electronic network/vending management unit 302 and to the terminals 304, 306. The desired digital file source 310 may be a library of electronic products such as games, music files, image/video files, data files, books and so on, and thus may come from a third party provider.

POS station 312 may also be networked and various operative electronic connection 314, 316 show that the POS station may communicate with the terminal installed in commercial establishment 318 (for example for marketing purposes or to transfer access codes).

Components of this embodiment may function as discussed in reference to FIG. 1.

FIG. 4 is a schematic view of a network according to a second alternative embodiment of the invention. Player control network 402 and networked output circumscribed player terminals 404, 406 once again have operative electronic connections 408a, 408c between them and POS station 412; operative electronic connections 414, 416 and commercial establishment 418 are much as described in other embodiments. In this embodiment, the source of the digital files is within the overall network, either centralized (for example, at control-of-player network 402 or one of the machines of the network) or is distributed, perhaps a subset of the sum total of the files being present on each machine in the network, with additional RAID type back-ups within the system to allow recovery of any files from any crashed or damaged mass storage in an individual machine.

Note that in the embodiments of FIGS. 3 and 4, it is possible for the POS station to send the access code directly to the output circumscribed player terminal.

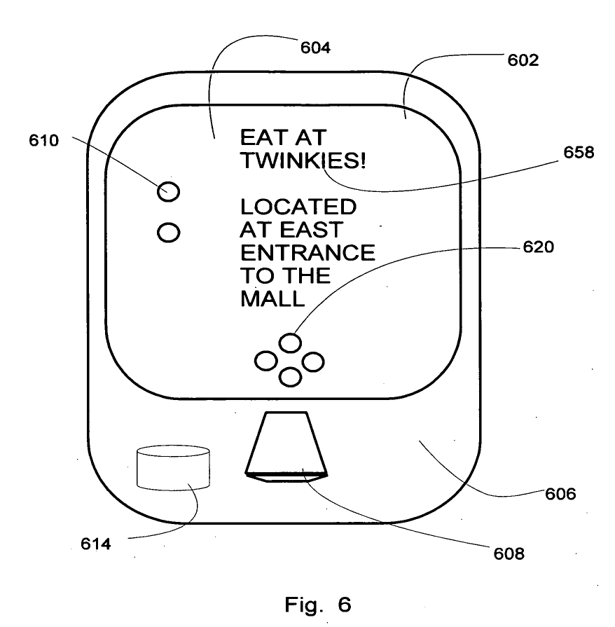

FIG. 6 is a front view of a output circumscribed player terminal according to another alternative embodiment of the invention. Output circumscribed player terminal 602, much like embodiments previously described, has a quite large video screen 604 having a speaker mounted therein. This embodiment shows that the device may visually appear to be nothing more than a large touch sensitive screen and a barcode scanner. Terminal 602 also has body 606, code scanner 608, video softbutton 610, player controls 620 which may be playback controls (play, pause, rewind, etc) or game controls (up, down, fast, slow, jump, kick, shoot, etc) and download management module/access limitation module/memory module/play control module/utility module 614. In presently preferred embodiments, such multipurpose control modules as 614 are obviously microprocessors having normal accouterments thereof: memory, mass storage devices, I/O controls and the like. It is anticipated that memory storage devices such as hard drives, optical drives, mass ROM, PROM, RAM and the like will feature prominently as this aspect of the device allows reprogramming to different types of file accesses: a game file access at one time, a video file access or music file access at a different time, or in response to different access codes, user choices and the like. This embodiment uses a standard scanner 608 to read access codes printed in machine readable format, which is the preferred embodiment and best mode now contemplated. There are numerous such formats, such as bar codes, machine readable numerals, and the pseudo-random patterns used in modern postage metering schemes. All such formats now known or later developed may be used to print and scan the access code.

Advertisement 658 shows that the device may advertise not just the digital files for play thereon and the products of the commercial establishment itself, but also other establishments.

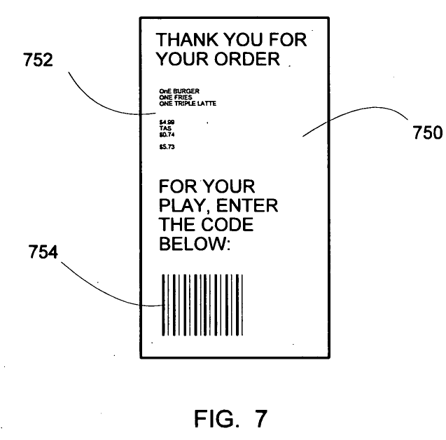

FIG. 7 is a frontal view of a POS station printed receipt according to the presently preferred mode of the invention. Receipt 750 has printed thereon indicia of a purchase or promotion 752 as a normal receipt may have, but also has an access code. The code depicted may be a bar code, but may in embodiments also be a number for manual entry or the like.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A method of accessing digital files comprising the steps of:
a) providing to a commercial establishment having pre-existing customer traffic an access controlled and output circumscribed player terminal located at the commercial establishment;
b) distributing an access code at a point of sale station at the commercial establishment;
c) inputting the access code at the output circumscribed player terminal; and
d) accessing a digital file for play on the player terminal.

2. The method of accessing digital files of claim 1, wherein the digital file further comprises one member selected from the group consisting of: MP3 files, music files, video files, data files, book files, text files, game files and combinations thereof.

3. The method of accessing digital files of claim 1, further comprising the step of:
e) providing video advertising on the terminal when not in use.

4. The method of accessing digital files of claim 1, wherein the access code further identifies the digital file to be downloaded.

5. The method of accessing digital files of claim 1, wherein the terminal further comprises at least one softbutton identifying the source of the digital file to play, and further comprising the step of:
c1) selecting the digital file to play.

6. The method of accessing digital files of claim 1, wherein the distribution of the access code further comprises a sale of the commercial establishment.

7. The method of accessing digital files of claim 1, wherein the inputting the access code at the output circumscribed player terminal further comprises one member selected from the group consisting of: scanning in a machine code, reading an electronic code, punching in a code manually on a keypad, and combinations thereof.

8. The method of accessing digital files of claim 1, wherein the step d) of accessing a digital file for play on the output circumscribed player terminal further comprises one member selected from the group consisting of: d1) downloading the digital file from a large electronic network to the output circumscribed player terminal, d2) retrieving the digital file from memory within the output circumscribed player terminal or combinations thereof.

9. The method of accessing digital files of claim 1, further comprising:
e) limiting access to the digital file for play on the output circumscribed player terminal by means of one member selected from the group consisting of: limiting access based upon time, limiting access based upon date, limiting access to a number of plays of the digital file, limiting access to a period of time, limiting access based upon the code generated by the POS station, limiting access based upon the value of a purchase made at the POS station, limiting access based upon the identity of a purchase made at the POS station, limiting access based upon a consumer survey, and combinations thereof.

10. A digital file player system allowing a commercial establishment to promote digital file play, the player system comprising:
a) an output circumscribed player;
b) a code input device;
c) a download management module allowing download of at least one digital file to the output circumscribed player upon entry of a code at the code input device.

11. The digital file player system of claim 10, wherein the digital file further comprises one member selected from the group consisting of: MP3 files, music files, video files, data files, book files, text files, game files and combinations thereof.

12. The digital file player system of claim 10, further comprising:
d) a programmable softbutton allowing selection of at least one desired digital file to be played on the player.

13. The digital file player system of claim 10, further comprising:
e) a point-of-sale station having a module able to generate the access code.

14. The digital file player system of claim 10, further comprising:
f) an operative electronic connection to a large electronic network of the digital file.

15. The digital file player system of claim 10, further comprising:
g) an operative electronic connection to a terminal control unit having a module remotely altering the operation of the terminal.

16. The digital file player system of claim 10, further comprising:
h) playing controls suitable for playing one member selected from the group consisting of: a digital file game, a digital music file, a digital video file, and combinations thereof.

17. The digital file player system of claim 10, wherein the access code further comprises one member selected from the group consisting of: a bar-code, another machine code, an electronic code, a number, and combinations thereof.
